(19) United States
(12) Patent Application Publication
(10) Pub. No.: US 2006/0074632 A1
(43) Pub. Date: Apr. 6, 2006

(54) Ontology-based term disambiguation

(76) Inventors: Amit A. Nanavati, New Delhi (IN); Chinmoy Dutta, Mumbai (IN)

Correspondence Address: Frederick W. Gibb, III;McGinn & Gibb, PLLC, Suite 304, 2568-A Riva Road, Annapolis, MD, 21401, US

(21) Appl. No.: 10/955,255

(22) Filed: Sep. 30, 2004

(51) Int. Cl. G06F 17/27

(52) U.S. Cl. 704/9

(57) ABSTRACT

A given ontology is used to disambiguate one or more terms in a given document. The document is first scanned and the frequency of occurrence of the terms of the ontologies that occur in the document is computed. A unique path is selected to the ambiguous term in the ontology using the frequency of occurrence values in such a manner so as to select the most appropriate context for the ambiguous term in the document.

### FIELD OF THE INVENTION

The present invention relates a method of disambiguating one or more terms in a document or part thereof using an ontology. The invention also relates to a computer program product comprising code means for implementing the steps of the method, and a computer system comprising computer software recorded on a computer-readable medium for performing the steps of the method.

### BACKGROUND

Traditionally, two kinds of systems have been defined during the long history of word sense disambiguation (WSD): principled systems that define which knowledge types are useful for WSD, and robust systems that use the information sources at hand, such as, dictionaries, light-weight ontologies or hand-tagged corpora. Principled systems attempt to describe the desired kinds of knowledge and proper methods to combine them. In contrast, robust systems tend to use whatever lexical resource they have at hand, either Machine Readable Dictionaries (MRD) or lightweight ontologies. An alternative approach consists on hand-tagging word occurrences in corpora and training machine learning methods on them. Parts-of-speech, morphology and collocations are in the first category, while ontology and corpora-based approaches are examples of the second category. However, these previous ontology based approaches have limited application and do not consistently disambiguate terms.

### SUMMARY

The proposed method makes use of a given ontology to disambiguate terms in a given document. Specifically, it uses the structure and content of the ontology to disambiguate the context of a term as it appears in the document. Such ontologies are typically created and agreed upon by experts and are therefore “standardised”. The inventors have found that the frequency of occurrence of terms that are near to a term T in the ontology can be used to determine the principle context in which T is being used in the document.

For disambiguating term T, the proposed method uses all the other ontology-terms that appear in the document along with their occurrence frequencies, and then traverses the ontology structure to determine the context (“sense”) in which T appears in the document. Since the preferred method does not rely on NLP-based techniques, it does not suffer from the limitations of such approaches. Another advantage of this approach is that one can plug in different ontologies depending on the level and nature of disambiguation required. In addition, the preferred method supports various ontology structures, such as: Directed Acyclic Graphs (DAGs), Collection of Trees (CT) and Collection of DAGs (CD). The steps of the proposed method are preferably implemented as software code for execution on a computer system.

### DESCRIPTION OF DRAWINGS

FIG. 1 illustrates a flow chart of a method of disambiguating one or more terms in a document using an ontology in accordance with a first arrangement.

FIG. 2 illustrates a flow chart of the sub-process ‘propagate_wt(vertex v)’ of step 130 of the method of FIG. 1.

FIG. 3 illustrates a flow chart of the sub-process ‘select_context(vertex v, vertex t)’ of step 140 of the method of FIG. 1.

FIG. 4 is a schematic representation of a computer system suitable for performing the techniques described herein.

### DETAILED DESCRIPTION

A brief review of terminology and notation used herein is first undertaken, then there is provided a detailed description of the preferred method of disambiguating one or more terms in a document using an ontology, a detailed description of computer software for implementing the steps of the method, and a detailed description of computer hardware that is suitable for executing such computer software.

Terminology

Ontology

In this document, the term “ontology” and “taxonomy” are used synonymously. An Ontology can have many possible structures, the most common among which are directed acyclic graphs (DAGs) and a collection of trees (CT). The methods described in this document work with both of them and a third structure, collection of DAGs (CD). A common feature of these Ontology structures is that they each comprise one or more root vertices, a plurality of descendent vertices, and a plurality of descendent leafs, where the descendent vertices and leafs correspond to respective terms, that is words, in the Ontology. An Ontology that has a DAG structure may have a vertex that has multiple parents which is a source of ambiguity. An Ontology that has a CT structure comprise vertices, where each vertex has only one parent. A vertex may appear in multiple trees. In this CT structure, transitivity does not hold across trees. An Ontology that has a CD structure comprises multiple DAGs. In this CD structure a vertex may have multiple parents and may appear in multiple DAGs. Also transitivity does not hold across the DAGs.

Ambiguity

A term is ambiguous when there are several paths in the ontology leading to it. Ambiguity arises in a DAG Ontology structure when there are several paths to a single vertex. Ambiguity arises in CT/CD Ontology structures where there are multiple vertices denoting the same term.

Context

A context is defined as a unique path in the ontology from the root to the term.

Notation

Pt denotes the set of all paths from the root to a term t in the entire ontology.

wt denotes the frequency of occurrence of term t in the document. In other words, the term wt denotes the weight associated with vertex t.

f is a propagation factor in [0,1] and is independent of the weight wᵥ. Namely, the propagation factor f can take a value between 0 and 1 inclusive. The propagation factor f determines what fraction of the weight wᵥ contributes to the parent in the tree. Preferably, f is a constant, however, in alternative embodiment(s), f can be tunable, namely a function of, the level in the tree, the number of children, a weight on the edge, or just any arbitrary number. Furthermore, these edge-weights may be used to incorporate an experts domain knowledge. For example, in the MeSH ontology, “Cyclin A” is a child of “cyclin” which is a child of “growth substances”. As the former parent-child relationship is “stronger” than the latter. This can be captured by assigning weight to the edges, which can be used in defining the propagation factor f.

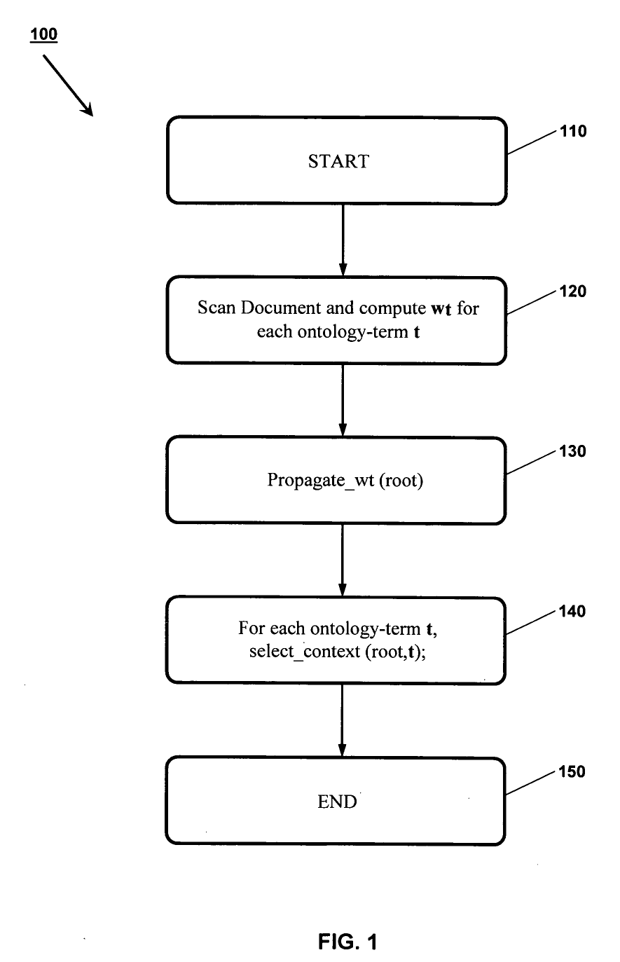

Turning now to FIG. 1, there is shown a flow chart of a method 100 of disambiguating one or more terms in a document using an ontology in accordance with a first arrangement. For ease of explanation, the method 100 is described with reference to a single ontology structure comprising a Directed Acyclic Graph (DAG), however the method 100 is not intended to be limited to a single ontology structure or a ontology structure comprising a DAG. The method 100 can also be used on a plurality of ontologies and also on other ontology structures such as collection of trees (CT) and a collection of DAGs (CD). Furthermore, the method 100 can also be used on a part of document. Generally speaking, the method 100 selects all the ontology-terms in the document, traverses the ontology, and outputs a disambiguating context for each term. In this way, the present method 100 consistently selects the most appropriate context for the ambiguous term.

The method 100 commences at step 110 where the document and ontology are retrieved and any necessary parameters are initialised. The method 100 then proceeds to step 120, where the method 100 scans the document and computes and stores the frequency of occurrence wt for each term t of the ontology in the document.

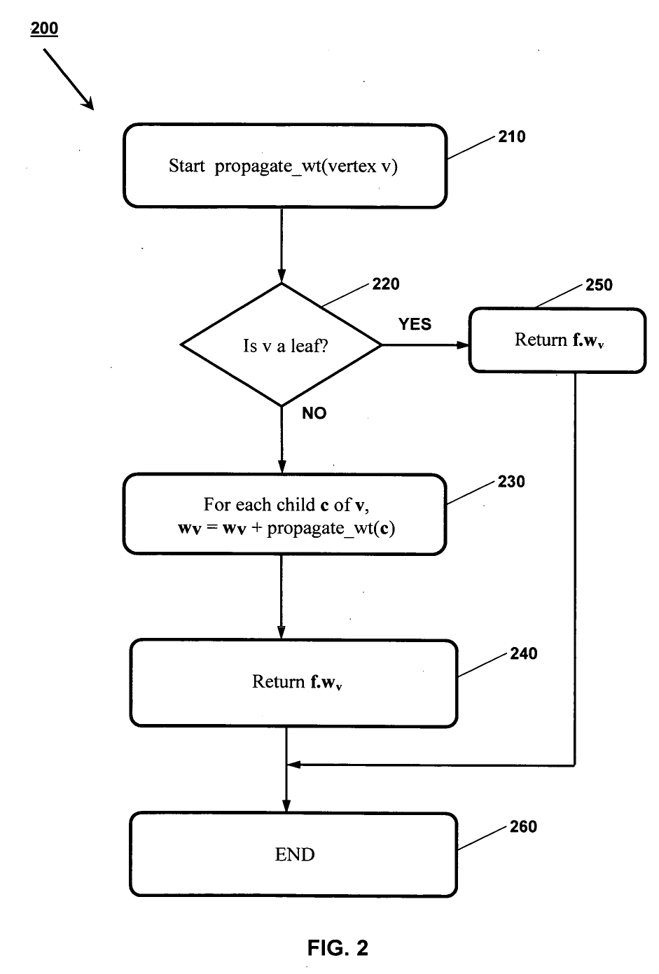

After completion of step 120, the method 100 then proceeds to step 130, where the method 40 calls a sub-process 200 ‘propagate_wt(vertex v)’, and passes the root vertex of the DAG of the ontology structure as the vertex v to this sub-process 200. The sub-process ‘propagate_wt(root)’ 200 recomputes and stores for each leaf and vertex v of the DAG an updated frequency occurrence value wᵥ. This updated frequency occurrence value wᵥ in the case of a vertex v equals the sum of the old frequency occurrence value wᵥ associated with that vertex v and the updated frequency occurrence values of its immediate descendants times the propagation factor(s) f_{c} for those descendents. The frequency occurrence value for a leaf v remains unchanged. This sub-process 200 will be described below in more detail with reference to FIG. 2.

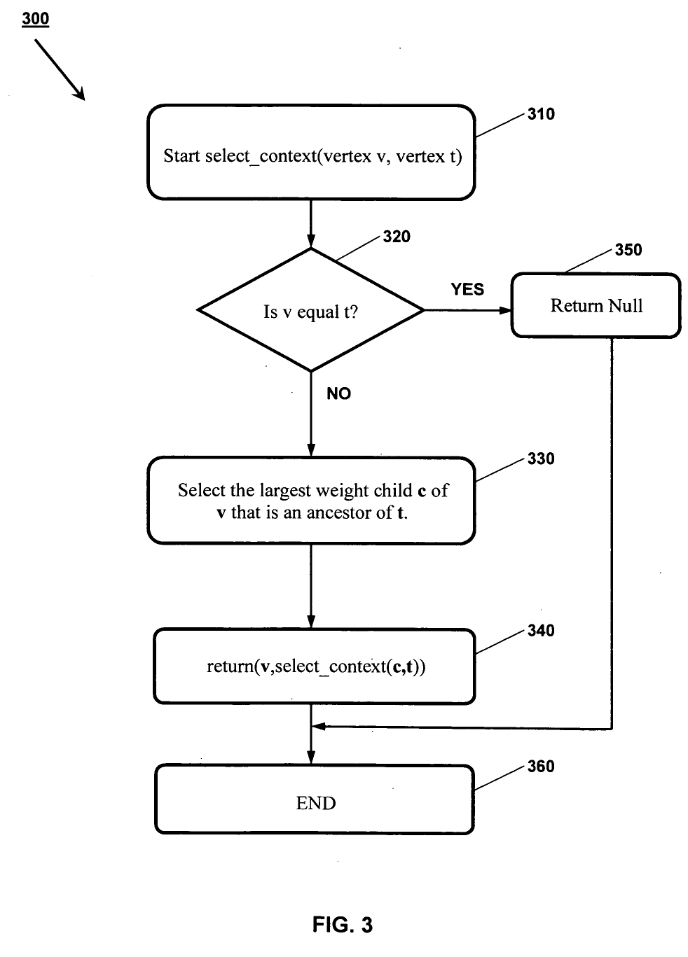

After completion of the sub-process 200, the method 100 proceeds to step 140, where the method 100 calls a sub-process 300 ‘select_context(vertex v, vertex t)’ for each term t in the ontology and passes to the sub-process 300 the root vertex as the vertex v and the vertex or leaf t corresponding to the term t as the vertex t. This sub-process 300 then selects a unique path in the ontology from the set of all paths Pₜ from the root to the term t. Specifically, the sub-process 300 selects that unique path from the root to the term t in such a manner that a child c having the largest updated frequency value wᵥ of a vertex v of the path is also a member of the path. The sub-process 300 returns this unique path for the term t as a sequence of vertices defining this unique path. After the completion of the sub-process 300 for a term t, the sub-process 300 is called again for the next term t in the ontology. After the sub-process 300 has processed all the terms t in the ontology, the method 100 then terminates at step 150. This sub-process 300 will be described below in more detail with reference to FIG. 3.

Turning now to FIG. 2, there is shown a flow chart of the sub-process ‘propagate_wt(vertex v)’ of step 130 of the method of FIG. 1. The sub-process 200 propagate_wt (vertex v) is a recursive sub-process and commences at step 210 where the root vertex is initially passed to the sub-process 200 as the current vertex v. The sub-process 200 then proceeds to a decision block 220, where a check is made whether the current vertex v is a leaf. If the decision block 220 determines that the current vertex v is a leaf then the sub-process 200 proceeds to step 250 where the sub-process 200 returns the value f.wᵥ, which value is equal to the propagation factor f for the current leaf times the frequency of occurrence value wᵥ for the current leaf v. As mentioned above the propagation factor f is a value independent of the weight wᵥ, and can be a predetermined constant, or may be variable whose value is decided based upon the consideration of many factors. If, on the other hand, the decision block 220 determines the current vertex v is not a leaf, then the sub-process 200 proceeds to step 230.

During step 230, the sub-process computes the updated frequency of occurrence value wᵥ for the current vertex v. As mentioned above, this updated frequency occurrence value wᵥ in the case of a vertex v equals the sum of the old frequency occurrence value wᵥ associated with that vertex v and the updated frequency occurrence values of its immediate descendants times the propagation factor(s) f_{c} associated with those descendents. Namely, the updated frequency occurrence value wᵥ for a vertex v equals

$${w}_{v} = {w}_{v} + {\sum }_{c} {f}_{c} \cdot {w}_{c} ,$$

where w_{c} are the previously updated frequency occurences values for the child vertices of the vertex v. The step 230 achieves this by determining, for each child vertex c of the current vertex v, the sum wᵥ=wᵥ+propagate_wt(c), where the sum recursively calls the sub-process propagate_wt (c) for each child vertex c of the current vertex v. After the completion of step 230, the sub-process 200 proceeds to step 240, where the sub-process 200 returns the current value of the propagation factor f.wᵥ. After the completion of either of the steps 250 or step 240, the sub-process 200 then terminates 260, and the method then proceeds to step 140.

In this fashion, the sub-process 200 computes the updated frequency of occurrence values wᵥ, whereby these values wᵥ increase in value along all paths from the leafs to the root of the ontology. Thus where a term is ambiguous in the DAG ontology structure, namely there are several paths to the vertex corresponding to that term, the most appropriate context, that is the unique path, can be consistently selected for that term using the updated frequency of occurrences values wᵥ. The sub-process 300 of FIG. 3 performs this selection process, which will now be described in more detail.

Turning now to FIG. 3, there is shown a flow chart of the sub-process ‘select_context(vertex v, vertex t)’ of step 140 of the method of FIG. 1. As mentioned previously, the sub-process 300 ‘select_context(vertex v, vertex t)’ is called for each term t in the ontology. The sub-process 300 ‘select_context(vertex v, vertex t)’ is a recursive sub-process and commences at step 310 where the root vertex is initially passed to the sub-process 300 as the current vertex v and the current vertex t is passed to the sub-process 300 as vertex t. The sub-process 300 then proceeds to a decision block 320, where a check is made whether the current vertex v is the same as the current vertex t. If the decision block 320 determines that the current vertices v and t are identical, then the sub-process 300 proceeds to step 350, where the sub-process 300 returns a Null value and the sub-process 300 terminates 360. On the other hand, if the decision block 320 determines that the current vertices v and t are not identical, then the sub-process 300 proceeds to step 330.

During step 330, the sub-process selects the immediately descendant (ie. child) vertex c of the current vertex v that is an ancestor of the current vertex t and that has the largest updated frequency value wᵥ. After the completion of step 330, the sub-process 300 proceeds to step 340, where the sub-process 300 performs a return operation return (v, select_context(c, t)). The second parameter of this return operation recursively calls the sub-process 300 ‘select_context (c, t)’ with the current vertex v set to the selected child vertex c. After the completion of the step 340, the sub-process 300 then terminates 360, and the method 40 then terminates.

In this fashion, the sub-process 300 selects the most appropriate context for each of the ontology terms t occurring in the document. Specifically the sub-process 300 for a term t returns a unique path in the form of a series of vertices commencing at the root vertex and finishing at the vertex t. followed the Null value. The sub-process 300 selects the unique path to the term t in the ontology in such a manner that where there are several paths branching from a single ancestor vertex of the unique path to a single descendant vertex, the sub-process 300 selects that immediately descendant vertex of the single ancestor vertex that has the largest updated assigned weight as the next member of the unique path. In this way, the combination of the sub-processes 200 and 300 consistently select a unique path for each term, and thus are able to disambiguate terms in the document.

As can be seen, the preferred method is not limited to any specific ontology, and different ontologies may be plugged in depending on the nature and level of disambiguation required. In this sense the preferred method is independent of domain ontology (taxonomy).

In a variation of the preferred method, the propagation factor f can be tunable, for example f can be a function of the edge weight, level depending on the actual ontology used.

The preferred method can also be used with CT ontologies subject to some modifications to selecting the context, that is the context selection sub-process 300. In the case of CT structures, a number of alternative ways of selecting the context are possible. Initially, the modified context selection sub-process first finds all the paths leading from the root to the term. In one variation the modified context selection sub-process then selects the path that has the maximum average weight per vertex. In another variation the modified context selection sub-process then selects the path that has the vertex with the largest weight. In still another variation the modified context selection sub-process selects the path with the largest sum of weights. The preferred method can also be used with CD ontologies subject to some modifications. The modified method for CD ontologies can be implemented by performing the context selection sub-process 300 independently on each of the DAGs, which results in a collection of trees, and then implementing one of aforementioned modified context selection sub-processes on these collection of trees.

In a still further variation of the preferred method, the method scans a part of the document and processes that part of the document to disambiguate terms occurring in that part of the document. This can have advantages where the document is very large and the term has different meanings in different parts of the document.

Computer Software

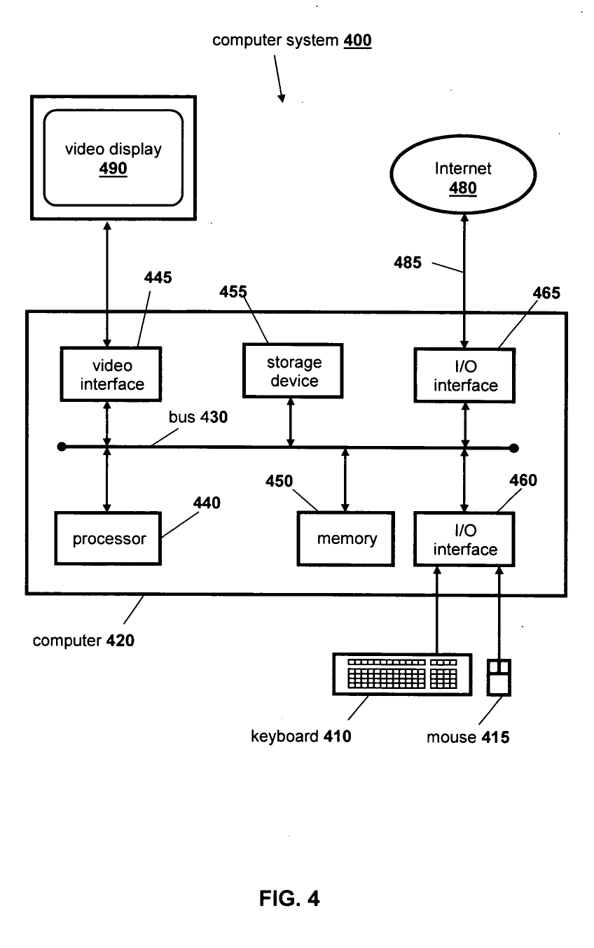

The steps of the preferred method 40 are preferably implemented as software code means for execution on a computer system such as that described with reference to FIG. 4. Exemplary pseudo software code for implementing the steps of the preferred method 40 is illustrated in Table 1 below.

TABLE 1
Scan the document and compute wt for each ontology-term t;
propagate_wt(root);
for each ontology-term t,

select_context (root, t);

Sub-routines:
propagate_wt(v)

if(v is a leaf) return f. wv
else

for each child c of v,
wv = wv + propagate_wt(c);

return f. wv

select_context(v,t)

if(v == t), return null;
else

select the largest weight child c of v that is an ancestor of t.
// Note that in the case of a DAG, t is a unique vertex,
// whereas in the case of CT/CD, t may appear as a
// collection of vertices.

return (v, select_context(c,t));

The pseudo code of Table 1 above is not intended to be limited to any particular programming language and implementation thereof. It will be appreciated that a variety of programming languages and implementations thereof may be used to implement the teachings of the invention as described herein.

Computer Hardware

FIG. 4 is a schematic representation of a computer system 400 of a type that is suitable for executing computer software for disambiguating one or more terms in a document or part thereof using an ontology. Computer software executes under a suitable operating system installed on the computer system 400, and may be thought of as comprising various software code means for achieving particular steps.

The components of the computer system 400 include a computer 420, a keyboard 440 and mouse 415, and a video display 490. The computer 420 includes a processor 440, a memory 450, input/output (I/O) interfaces 460, 465, a video interface 445, and a storage device 455.

The processor 440 is a central processing unit (CPU) that executes the operating system and the computer software executing under the operating system. The memory 450 includes random access memory (RAM) and read-only memory (ROM), and is used under direction of the processor 440.

The video interface 445 is connected to video display 490 and provides video signals for display on the video display 490. User input to operate the computer 420 is provided from the keyboard 44 and mouse 415. The storage device 455 can include a disk drive or any other suitable storage medium.

Each of the components of the computer 420 is connected to an internal bus 430 that includes data, address, and control buses, to allow components of the computer 420 to communicate with each other via the bus 430.

The computer system 400 can be connected to one or more other similar computers via a input/output (I/O) interface 465 using a communication channel 485 to a network, represented as the Internet 480.

The computer software may be recorded on a portable storage medium, in which case, the computer software program is accessed by the computer system 400 from the storage device 455. Alternatively, the computer software can be accessed directly from the Internet 480 by the computer 420. In either case, a user can interact with the computer system 400 using the keyboard 44 and mouse 415 to operate the programmed computer software executing on the computer 420.

Other configurations or types of computer systems can be equally well used to execute computer software that assists in implementing the techniques described herein.

### CONCLUSION

Various alterations and modifications can be made to the techniques and arrangements described herein, as would be apparent to one skilled in the relevant art.

1. A method of disambiguating one or more terms in a document or part thereof using an ontology, wherein said ontology comprises a plurality of terms, said method comprising:
scanning the document or part thereof;
assigning weights to the terms in the ontology representative of a frequency of occurrence of the terms in the document; and
determining, for each term in the ontology, a unique path to the term in the ontology using the assigned weights, in order to disambiguate a meaning of the one or more terms in the document.

2. The method of claim 1, wherein the ontology comprises a directed acyclic graph, wherein the terms in the ontology correspond to respective vertices in the directed acyclic graph.

3. The method of claim 2, wherein the determining process comprises:
updating the assigned weights, wherein the updated assigned weights increase in value along all paths from leafs to a root of the ontology; and
selecting, for each term in the ontology, a unique path to the term in the ontology in such a manner that where there are several paths branching from a single ancestor vertex of the unique path to a single descendant vertex, selecting that immediately descendant vertex of the single ancestor vertex that has a largest updated assigned weight as a next member of the unique path.

4. The method of claim 1, wherein the ontology comprises a collection of trees, wherein the terms in the ontology correspond to respective vertices in the collection of trees.

5. The method of claim 5, wherein the determining process comprises:
selecting, for each term in the ontology, a unique path to the term in the ontology in such a manner that where there are several paths from a root to the term in the ontology, selecting that path that has a maximum average assigned weight per vertex.

6. The method of claim 5, wherein the determining process comprises:
selecting, for each term in the ontology, a unique path to the term in the ontology in such a manner that where there are several paths from a root to the term in the ontology, selecting that path that has a vertex with a largest assigned weight.

7. The method of claim 5, wherein the determining process comprises:
selecting, for each term in the ontology, a unique path to the term in the ontology in such a manner that where there are several paths from a root to the term in the ontology, selecting that path that has vertices with a largest sum of assigned weights.

8. The method of claim 1, wherein the ontology comprises a collection of directed acyclic graphs, wherein the terms in the ontology correspond to respective vertices in the directed acyclic graphs.

9. The method of claim 1, wherein the ontology comprises one or more vertices each having multiple parent vertices and one or more vertices that appear in multiple directed acyclic graphs.

10. The method of claim 9, wherein the determining process, for each one of the multiple directed acyclic graphs comprises:
updating assigned weights of the directed acyclic graph, wherein the updated assigned weights increase in value along all paths from leafs to a root of a directed acyclic graph; and
selecting, for each term in the directed acyclic graph, a first path to the term in the directed acyclic graph in such a manner that where there are several paths branching from a single ancestor vertex of the first path to a single descendant vertex, selecting that immediately descendant vertex of the single ancestor vertex that has a largest updated assigned weight as a next member of the first path.

11. The method of claim 10, wherein the determining process further comprises:
selecting, for each term in the ontology, a unique path to the term in the ontology in such a manner that where there are several first paths from the root to the term in the ontology, selecting that first path that has a maximum average assigned weight per vertex.

12. The method of claim 10, wherein the determining process further comprises:
selecting, for each term in the ontology, a unique path to the term in the ontology in such a manner that where there are several first paths from the root to the term in the ontology, selecting that first path that has a vertex with a largest assigned weight.

13. The method of claim 10, wherein the determining process further comprises:
selecting, for each term in the ontology, a unique path to the term in the ontology in such a manner that where there are several first paths from the root to the term in the ontology, selecting that first path that has vertices with a largest sum of assigned weights.

14. The method of claim 1, further comprising supporting various ontological structures for term disambiguation in said document.

15. The method of claim 14, wherein the ontological structures comprise experts domain knowledge by attaching weights in the ontology, which are used for updating the assigned weights.

16. A method of determining a context of a term in a document or part thereof using an ontology, said method comprising:
scanning the document or part thereof;
assigning weights to terms in the ontology representative of a frequency of occurrence of the terms in the document; and
determining a context of a term that is used in the document by using the weights assigned to the terms that are near to the term in the ontology.

17. A computer program product for disambiguating one or more terms in a document or part thereof using an ontology, the computer program product comprising computer software recorded on a computer-readable medium for performing a method comprising:
scanning the document or part thereof;
assigning weights to the terms in the ontology representative of a frequency of occurrence of the terms in the document; and
determining, for each term in the ontology, a unique path to the term in the ontology using the assigned weights, in order to disambiguate a meaning of the one or more terms in the document.

18. A computer program product for determining a context of a term in a document or part thereof using an ontology, the computer program product comprising computer software recorded on a computer-readable medium for performing a method comprising:
scanning the document or part thereof;
assigning weights to terms in the ontology representative of a frequency of occurrence of the terms in the document; and
determining a context of a term that is used in the document by using the weights assigned to the terms that are near to the term in the ontology.

19. A computer system for disambiguating one or more terms in a document or part thereof using an ontology, the computer system comprising computer software recorded on a computer-readable medium for performing a method comprising:
scanning the document or part thereof;
assigning weights to the terms in the ontology representative of a frequency of occurrence of the terms in the document; and
determining, for each term in the ontology, a unique path to the term in the ontology using the assigned weights, in order to disambiguate a meaning of the one or more terms in the document.

20. A computer system for determining the context of a term in a document or part thereof using an ontology, the computer system comprising computer software recorded on a computer-readable medium for performing a method comprising:
scanning the document or part thereof;
assigning weights to terms in the ontology representative of a frequency of occurrence of the terms in the document; and
determining a context of a term that is used in the document by using the weights assigned to the terms that are near to the term in the ontology.
